(19) United States
(12) Patent Application Publication
(10) Pub. No.: US 2011/0312204 A1
(43) Pub. Date: Dec. 22, 2011

(54) CONNECTOR MODULE AND CONNECTOR

(76) Inventors: Po-Wen SHIH, Taipei (TW); Hsin-Yi CHEN, Taipei (TW)

(21) Appl. No.: 13/163,295

(22) Filed: Jun. 17, 2011

Related U.S. Application Data
(60) Provisional application No. 61/355,569, filed on Jun. 17, 2010.

(51) Int. Cl. H01R 13/62

(52) U.S. Cl. 439/345

(57) ABSTRACT

A connector module and a connector are provided. The connector module includes a first connecting unit and a second connecting unit. The first connecting unit is disposed at a motherboard. The first connecting unit includes a plurality of pins, a plurality of slots and a fastener. The pins are disposed in the slots correspondingly. A plane joint surface and a curved guiding surface are formed at the fastener. The second connecting unit includes a fastening hook. When the first connecting unit and the second connecting unit are connected, the connecting surface contacts the fastening hook.

### CROSS REFERENCE TO RELATED APPLICATIONS

This application claims benefit of priority to a provisional U.S. Application No. 61/335,569, filed Jun. 17, 2010, the disclosures of which are fully incorporated herein by reference.

### BACKGROUND OF THE INVENTION

1. Field of Invention

The invention relates to a connector and, more particularly, to a power connector.

2. Related Art

Conventionally, a power supply is connected to a motherboard via a connector. The connector includes a male connector and a female connector. The female connector is disposed at the motherboard, the power supply is connected to the male connector via multiple cables, and the male connector and the female connector are fastened to be electrically connected to each other.

As the processing speed of the motherboard becomes higher, the requirement of electronic components increases, and also the heat dissipation increases. Thus, the space for disposing electronic components, heat dissipation components and assembling the connectors is limited, and the male connector is not easily detached in a limited space. Moreover, the connector may be damaged when detached.

### SUMMARY OF THE INVENTION

The connector module includes a first connecting unit and a second connecting unit. A fastener is formed outside of the first connecting unit. The fastener includes a joint surface and a guiding surface. The second connecting unit includes a fastening hook. The joint surface is a plane surface, and the guiding surface is a curved surface. When the first connecting unit is connected to the second connecting unit, the joint surface contacts the fastening hook.

A connector disposed at a motherboard is further disclosed. The connector includes a plurality of pins, a plurality of slots and a fastener. The pins are disposed in the slots correspondingly. The fastener includes at least a joint surface and at least a guiding surface. The joint surface is a plane surface, and the guiding surface is a curved surface.

In an embodiment, the connector may be a 4-pin connector, an 8-pin connector, a 12-pin connector, or a 24-pin connector.

In an embodiment, the connector may be a power connector, such as an advanced technology extended (ATX) power connector. However, it is not limited herein.

As stated above, a joint surface and a guiding surface are formed at the fastener at the first connecting unit of the connector. Users can fasten the fastening hook of the second connecting unit to the fastener of the first connecting unit by sliding.

The connector facilitates detaching the female connector from the male connector easily even if the disposing and assembly space is limited, which is more convenient and efficient in detaching the connector. Consequently, it can prevent the connector from being damaged while detaching and ensure the connection reliability of the connector.

These and other features, aspects and advantages of the present invention will become better understood with regard to the following description, appended claims, and accompanying drawings.

### BRIEF DESCRIPTION OF THE DRAWINGS

FIG. 1 is an exploded diagram showing a connector in an embodiment;

FIG. 2 is a side view showing the connector in FIG. 1; and

FIG. 3 is a side view showing a connector in a second embodiment.

### DETAILED DESCRIPTION OF THE INVENTION

A connector in an embodiment is illustrated with relating figures. The same symbols denote the same components.

In the embodiment, the connector is a power connector such as, but not limited to, an ATX power connector. In detail, the connector can be connected to a power supply and a motherboard. The connector may be a 4-pin connector, an 8-pin connector, a 12-pin connector, or a 24-pin connector.

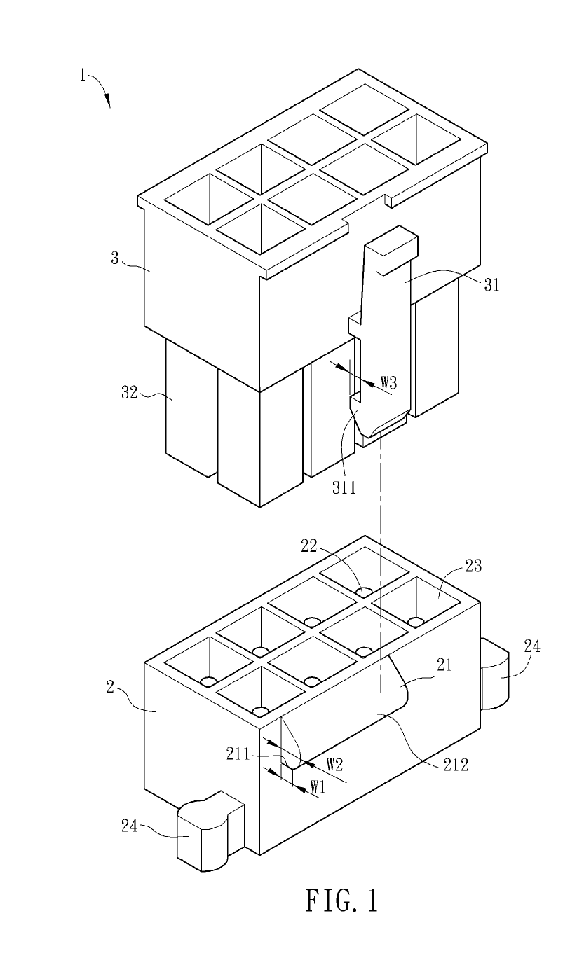

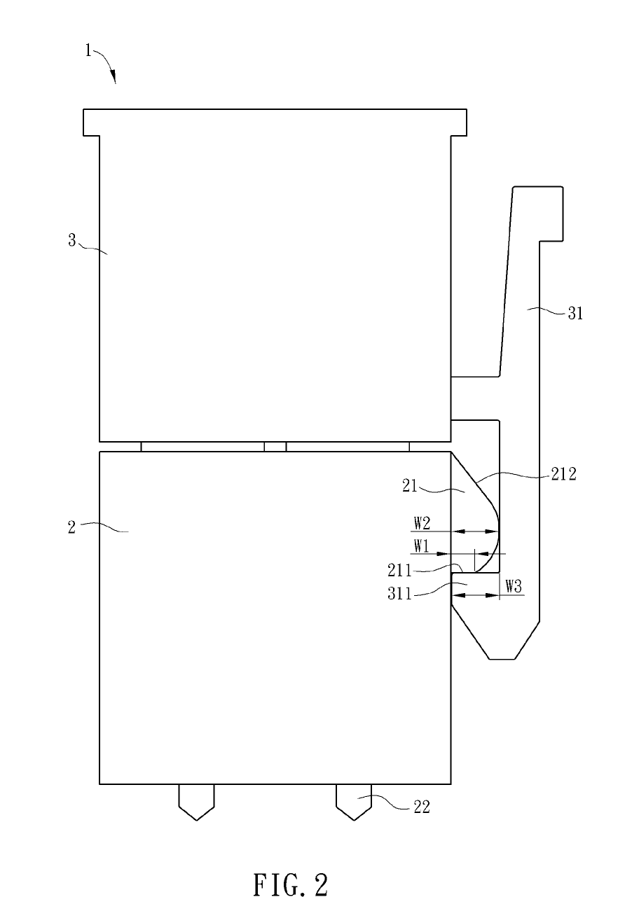

FIG. 1 is an exploded diagram showing the connector in an embodiment. FIG. 2 is a side view showing the connector in FIG. 1. In the embodiment, an 8-pin connector is taken as an example, which is not limited herein. The connector module 1 includes a first connecting unit 2 and a second connecting unit 3. The first connecting unit 2 and the second connecting unit 3 are connected via a hook. The first connecting unit 2 disposed at (connected to) the motherboard is taken as an example. The second connecting unit 3 connected to the power supply is taken as an example, which is not limited herein.

A fastener 21 is formed at the outside of the first connecting unit 2. The fastener 21 includes at least a joint surface 211 and at least a guiding surface 212. The joint surface 211 is a plane surface, and the guiding surface 212 is a curved surface. In the embodiment, the fastener 21 includes the joint surface 211 and the guiding surface 212. The fastener may also includes a plurality of the joint surfaces and a plurality of the guiding surfaces, and the guiding surface may be in other shapes such as a circle, a paraboloid, an ellipse, or other regular or irregular curved surface.

Furthermore, the first connecting unit 2 includes a plurality of pins 22 and a plurality of slots 23. The pins 22 are disposed in the slots 23 correspondingly. If the first connecting unit 2 includes 8 slots 23, the first connecting unit 2 includes 8 pins 22 correspondingly, and the 8 pins 22 are disposed in the 8 slots 23, respectively. Moreover, the first connecting unit 2 further includes at least a protruding part 24. The protruding part 24 is formed at one side of the first connecting unit 2. In the embodiment, the first connecting unit 2 includes two protruding parts 24 formed at two opposite sides of the first connecting unit 2, respectively.

The second connecting unit 3 includes a fastening hook 31 formed at one side of the second connecting unit 3. A hook 311 of the fastening hook 31 has a third width W3. Additionally, the second connecting unit 3 in the embodiment further includes a plurality of connecting parts 32. The connecting parts 32 are disposed corresponding to the slots 23 of the first connecting unit 2.

In an embodiment, the joint surface 211 has a first width W1, the guiding surface 212 has a second width W2, and the first width W1 is smaller than the second width W2. The first width W1 of the joint surface 211 is the width between the side of the first connecting unit 2 with the fastener 2 and the connecting part between the joint surface 211 and the guiding surface 212. The second width W2 of the guiding surface 212 is the width between the side of the first connecting unit 2 with the fastener 21 and the protruding point of the guiding surface 212 of the fastener 21.

In the embodiment, the first width W1 of the joint surface 211 may be less than the third width W3 of the hook 311 of the fastening hook 31 when the hook 311 is fastened to the joint surface 211 firmly. The second width W2 of the guiding surface 212 is not larger than (less than or equal to) the third width W3 of the hook 311 of the fastening hook 31.

Since the first width W1 is less than the third width W3, the contact area between the joint surface 211 of the fastener 21 and the hook 311 of the fastening hook 31 is small. Moreover, the guiding surface 212 formed at the fastener 21 makes the hook 311 of the fastening hook 31 slide along the guiding surface 212 when the fastening hook 31 contacts the fastener 21, so as to make the hook 311 of the fastening hook 31 of the second connecting unit 3 fastened to the joint surface 211 of the fastener 21 of the first connecting unit 2 easily. To detach the second connecting unit 3 from the first connecting unit 2, since the contacting area between the joint surface 211 and the hook 311 is small, the user only needs to push the fastening hook 31 slightly to detach the hook 311 of the fastening hook 31 of the second connecting unit 3 from the joint surface 211 of the fastener 21 of the first connecting unit 2.

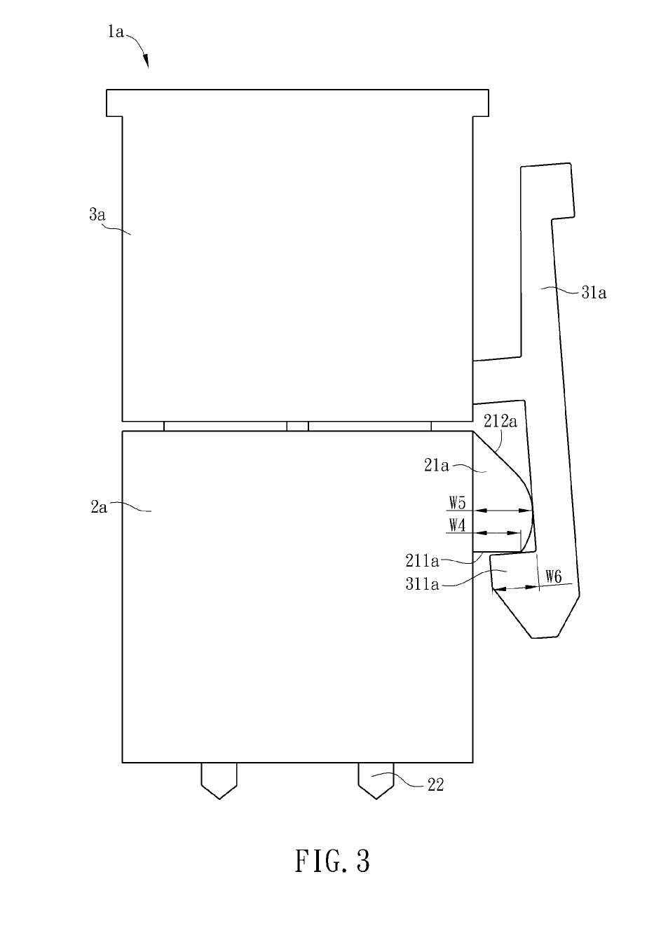

FIG. 3 is a side view showing a connector in a second embodiment. The connector module 1a includes a first connecting unit 2a and a second connecting unit 3a. A fastener 21a is formed at the outside of the first connecting unit 2a. The fastener 21a includes at least a joint surface 211a and at least a guiding surface 212a. The joint surface 211a has a first width W4, the guiding surface 212a has a second width W5, and the first width W4 is less than the second width W5. The second connecting unit 3a includes a fastening hook 31a, and a hook 311a of the fastening hook 31a has a third width W6.

In the embodiment, the first width W4 of the joint surface 211a substantially equals to the third width W6 of the hook 311a of the fastening hook 31a. The term “substantially equals to” means the difference therebetween is within the manufacturing tolerance. The second width W5 of the guiding surface 212a is larger than the third width W6 of the hook 311a of the fastening hook 31a.

In sum, the fastener of the first connecting unit of the connector includes a joint surface and a guiding surface. Users can fasten the fastening hook of the second connecting unit to the fastener of the first connecting unit by sliding. Thus, the male connector can be detached from the female connector easily even if the disposing and assembly space decreases, which is more convenient and efficient in detaching the connector. Consequently, it can prevent the connector from being damaged and ensure the connection reliability of the connector.

Although the present invention has been described in considerable detail with reference to certain preferred embodiments thereof, the disclosure is not for limiting the scope of the invention such as the width in the specification. It is to be understood that any fastening structure with a curved guiding surface is within the scope of the invention. Persons having ordinary skill in the art may make various modifications and changes without departing from the scope. Therefore, the scope of the appended claims should not be limited to the description of the preferred embodiments described above.

What is claimed is:

1. A connector module comprising:
a first connecting unit, wherein a fastener is formed outside of the first connecting unit, and the fastener includes a joint surface and a guiding surface; and
a second connecting unit including a fastening hook;
wherein the joint surface is a plane surface, the guiding surface is a curved surface, and when the first connecting unit and the second connecting unit are connected, the joint surface contacts the fastening hook.

2. The connector module according to claim 1, wherein the first connecting unit further includes a plurality of pins and a plurality of slots, and the pins are disposed in the slots correspondingly.

3. The connector module according to claim 1, wherein the first connecting unit further includes at least a protruding part formed at one side of the first connecting unit.

4. The connector module according to claim 1, wherein the connector module is a power connector module.

5. A connector disposed at a motherboard, comprising:
a plurality of pins;
a plurality of the slots, wherein the pins are disposed in the slots correspondingly; and
a fastener including at least a joint surface and at least a guiding surface,
wherein the joint surface is a plane surface, and the guiding surface is a curved surface.

6. The connector according to claim 5, wherein the first connecting unit further includes at least a protruding part formed at one side of the first connecting unit.

7. The connector according to claim 5, wherein the connector module is a power connector.
